(19) United States
(12) Patent Application Publication
(10) Pub. No.: US 2026/0328594 A1
(43) Pub. Date: Oct. 22, 2026

(54) PLUGGABLE SENSOR MODULES

(71) Applicant: CISCO TECHNOLOGY, INC., San Jose, CA (US)

(72) Inventors: Esther Roure VILA, Alpicat Lleida (ES); Marisol Palmero AMADOR, Toledo (ES); Tiziano CANOVAI, LA Amsterdam (NL); Fabio BOTTONI, Milano (IT)

(21) Appl. No.: 19/186,041

(22) Filed: Apr. 22, 2025

(51) Int. Cl. G01D 5/26; G01D 21/02; G01H 9/00

(52) U.S. Cl. CPC G01D 5/268; G01D 21/02; G01H 9/004

(57) ABSTRACT

In one embodiment, a sensor module includes a distributed temperature sensing sub-system, a distributed acoustic sensing sub-system, and a distributed vibration sensing sub-system. The sensor module further includes a small form-factor pluggable (SFP) interface configured to couple to an optical fiber and a switch. The distributed temperature sensing sub-system, the distributed acoustic sensing sub-system, and the distributed vibration sensing sub-system are together configured to monitor optical power levels, wavelengths, temperatures, and voltages using the optical fiber and identify corresponding variations in one or more of temperature, sounds, or vibrations.

### FIELD

The present disclosure relates to fiber optic sensors and, more particularly, to fiber optic sensor devices using optical fiber for sensing different conditions.

### BACKGROUND

The statements in this section merely provide background information related to the present disclosure and may not constitute prior art.

Detecting environmental issues such as water leaks, forecasting infrastructure failures, or detecting seismic activity typically rely on a dedicated sensor network. Detecting each environmental issue normally involves using a separate sensor and system for detection.

### DRAWINGS

In order that the disclosure may be well understood, there will now be described various forms thereof, given by way of example, reference being made to the accompanying drawings, in which:

FIG. 1 is a functional block diagram illustrating a system that includes optical sensing devices in accordance with one or more embodiments;

FIG. 2 is a block diagram of a sensor in accordance with one or more embodiments;

FIG. 3 is a block diagram of a system architecture in accordance with one or more embodiments;

FIG. 4 is a diagram illustrating an implementation of optical sensing devices in accordance with one or more embodiments;

FIGS. 5 and 6 are diagrams illustrating another implementation of optical sensing devices in accordance with one or more embodiments;

FIG. 7 is a diagram illustrating another implementation of optical sensing devices in accordance with one or more embodiments;

FIGS. 8-12 are diagrams illustrating another implementation of optical sensing devices in accordance with one or more embodiments;

FIG. 13 is a diagram illustrating another implementation of optical sensing devices in accordance with one or more embodiments;

FIG. 14 is a functional block diagram illustrating event classification in accordance with one or more embodiments; and

FIG. 15 is a block diagram of a computing device in accordance with various embodiments.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

As will be discussed in more detail herein, systems, methods, and computer program products are provided for distributed sensing. In various embodiments, a sensor module includes a distributed temperature sensing sub-system; a distributed acoustic sensing sub-system; a distributed vibration sensing sub-system; and a small form-factor pluggable (SFP) interface configured to couple to an optical fiber and a switch, wherein the distributed temperature sensing sub-system, the distributed acoustic sensing sub-system, and the distributed vibration sensing sub-system are together configured to monitor optical power levels, wavelengths, temperatures, and voltages using the optical fiber and identify corresponding variations in one or more of temperature, sounds, or vibrations.

### Example Embodiments

Detecting environmental issues may be performed using a network of sensors, which can include different types of specialized sensors for performing different detections. As such, the cost to implement such network can be high and complex. For example, the implementation of a large number of specialized sensor types can be used with each sensor type designed to detect specific environmental issues. Accordingly, it is desirable to provide improved methods and systems for detecting environmental issues without implementing a dedicated sensor network, such as using detection specific sensor types. Furthermore, other desirable features and characteristics of the present disclosure will become apparent from the subsequent detailed description and the appended claims, taken in conjunction with the accompanying drawings and the foregoing technical field and background.

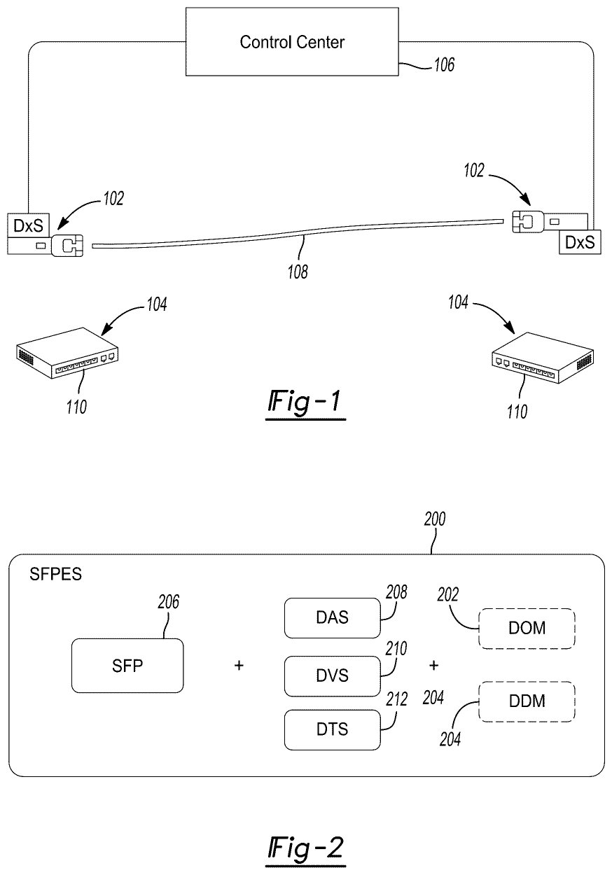

With reference to FIG. 1, a system 100 is shown that includes one or more optical sensing devices 102 in accordance with one or more embodiments. For example, the optical sensing devices 102 in one or more examples are configured as Small Form-factor Pluggable (SFP) modules with Distributed Temperature Sensing (DTS), Distributed Acoustic Sensing (DAS), and/or Distributed Vibration Sensing (DVS) capabilities. By detecting shifts in light wavelength or analyzing time delays, the optical sensing devices 102 can be arranged as a network of SFP modules that can precisely identify and classify the variations in, for example, temperature, sound, or vibrations, providing a multifaceted environmental monitoring solution.

As can be seen, the optical sensing devices 102 are pluggable devices capable of being coupled to a switch 104 that allows for communicating sensed data to a control center 106 as described in more detail herein. For example, the optical sensing devices 102 in one or more examples are interconnected with an optical fiber 108 (e.g., fiber optic cable), wherein each of the optical sensing devices 102 are configured to perform one or more types of distributed sensing, such as in a pipeline setting, including:
1. Distributed Temperature Sensing (DTS): allowing measurement of temperature changes along a pipeline. For example, a leak of CO₂ can cause a drop in temperature due to the expansion of the gas as the gas escapes, which can be detected by the DTS as described in more detail herein.
2. Distributed Acoustic Sensing (DAS): allowing detection of acoustic anomalies along the pipeline, such as the sound of gas escaping through a leak. DAS is highly sensitive and can locate the leak with considerable accuracy.
3. Distributed Strain Sensing (DSS): allowing strain sensing that can detect small changes in the physical structure of the pipeline. If a leak occurs, the pressure change can cause a deformation in the pipe material, which can be detected as a change in strain. In some embodiments, this includes or is used in combination with DVS.

In one or more embodiments, the optical sensing devices 102 are configured for DTS, DAS, and DVS operation with a SFP configuration. In operation, the optical sensing devices 102 use the DTS, DAS, and DVS functions and/or other fiber optic sensing technologies to monitor various physical conditions over large distances and areas in one or more examples. In some examples, the DTS, DAS, and DVS are not integrated directly into the SFP modules or fiber optic modules in line cards, but complement the data gathered by the SFP modules to provide a comprehensive overview of the health and performance of an optical network.

In one or more examples, the optical sensing devices 102 utilize optical sensor technology integrated into SFP modules or fiber modules, such as the SFPES module 200 shown in FIG. 2. The SFPES module 200 enables the monitoring of various parameters, such as optical power levels, wavelength, temperature, and voltage using an optical communication network having the optical fiber 108. The SFPES module 200 in one or more embodiments includes an SFP component 206 that allows the SFPES module 200 to be pluggable with a small-form factor connection arrangement. The SFPES module 200 further includes a DAS sub-system 208, a DVS sub-system 210, and a DTS sub-system 212. The DAS sub-system 208, the DVS sub-system 210, and the DTS sub-system 212 are configured to perform DAS, DVS, and DTS operations, respectively, using fiber optics. That is, distributed fiber sensing performed by the SFPES module 200 includes DAS for acoustic sensing, DVS for vibrational sensing, and DTS for temperature sensing. In various examples, the DAS for acoustic sensing, DVS for vibrational sensing, and distributed DTS for temperature sensing detect acoustic events, vibration events, and temperature events, respectively.

For example, the DAS sub-system 208 uses fiber optic cables as a sensor to measure strain or strain-rate along the fiber optic cable. The DVS sub-system 210 uses fiber optics cables as a sensor to measure seismic activity using the fiber optic cable as the sensor. The DTS sub-system 212 uses fiber optic cables to measure temperature along the entire length, providing continuous, real-time temperature profiles and high spatial resolution. In one or more embodiments, the DTS sub-system 212 uses the principle of Raman scattering, where light interacts with the molecules in the fiber, and the intensity of the scattered light (Raman anti-Stokes and Stokes signals) is temperature-dependent. The optical fiber acts as the sensor, such that temperature can be measured along the entire length of the fiber. For example, a short pulse of laser light is sent into the fiber, and the backscattered light is analyzed to determine temperature variations along the fiber. The ratio of Raman anti-Stokes and Stokes signals is used to determine the temperature at each location along the fiber. It should be appreciated that the DAS sub-system 208, the DVS sub-system 210, and the DTS sub-system 212 can be configured to perform sensing using any suitable fiber optic sensing technique that allows for performing measurements along the optical fiber 108 using the DAS sub-system 208, the DVS sub-system 210, and the DTS sub-system 212. In one or more embodiments, the DAS sub-system 208, the DVS sub-system 210, and/or the DTS sub-system 212 are configured to perform distributed sensing that enables continuous, real-time measurements along the entire length of a fiber optic cable (e.g., using light pulses to detect physical characteristics or changes thereof, such as temperature and strain, among other characteristics as described herein).

In some embodiments, the SFPES module 200 further includes built-in diagnostics, such as a Digital Optical Monitoring (DOM) sub-system 202 and/or a Digital Diagnostics Monitoring (DDM), which allow for real-time monitoring of the parameters. The data gathered by the SFPES module 200 in some examples is supplemented with additional resources.

In one or more embodiments, the SFPES module 200 forms part of a framework that includes:
Centralized Monitoring: a centralized monitoring system that obtain diagnostic data from SFPES modules 200 via a management interface (e.g., SNMP, I2C) implemented as part of the control center 106 and receive data streams from DAS, DVS, and DVS systems (e.g., the DAS sub-system 208, the DVS sub-system 210, and the DTS sub-system 212).
Data Correlation: advanced data analytics are used to correlate events detected by DTS, DAS, and DVS systems (e.g., the DAS sub-system 208, the DVS sub-system 210, and the DTS sub-system 212) with changes in optical signal performance as reported by the SFPES modules 200. This facilitates the identification of the cause of any issues and enables proactive maintenance.
Automated Alerts: automated alerts are set up and/or configured in a network management system to notify operators when certain thresholds are exceeded or when patterns indicative of specific faults are detected.
Predictive Maintenance: combined data is used to develop predictive maintenance models that can forecast potential network issues before the issues lead to failures, allowing for pre-emptive action to be taken.

It should be noted that while DTS, DAS, and DVS systems may be used in specialized applications and are not standard components of SFP modules, the data can facilitate maintaining the health and performance of optical networks, especially in critical or large-scale deployments.

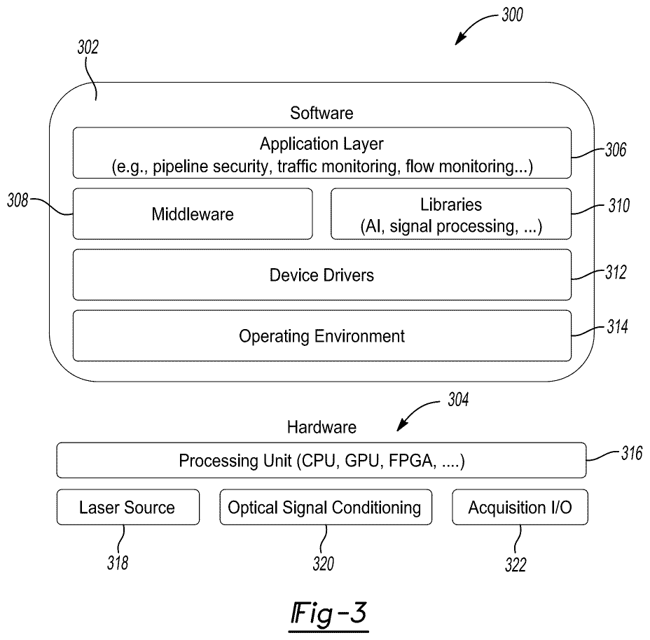

In one or more embodiments, a sensing architecture 300 as shown in FIG. 3 allows for performing DTS, DAS, and DVS as described in more detail herein. As can be seen, the sensing architecture 300 includes a software component 302 and a hardware component 304. The software component 302 includes an application layer 306 that is configured to perform application functions for one or more operations of the DTS, DAS, and DVS, such as pipeline security, traffic monitoring, flowing, etc. as described in more detail herein. The software component 302 further includes middleware 308 with one or more data libraries 310 that facilitate performing AI, signal processing, etc. One or more device drivers 312 are also provided as part of the software component 302 to drive one or more devices, such as the SFPES modules 200. The software component 302 also include an operating environment 314.

The hardware component 304 includes on or more processing units 316 (e.g., a CPU, GPU, FPGA, etc.) configured to control operation of one or more functions, such as one or more monitoring or detecting functions of the SFPES modules 200. The hardware component 304 also include a laser source 318 configured to generate a light source for the optical fiber 108, as well as an optical signal conditional sub-system 320 configured to condition the optical signal generated by the laser source 318. An acquisition input/output (I/O) component 322 of the hardware component 304 is configured to perform data communication operations, particularly acquisition of monitoring or sensing data, such as by the SFPES modules 200.

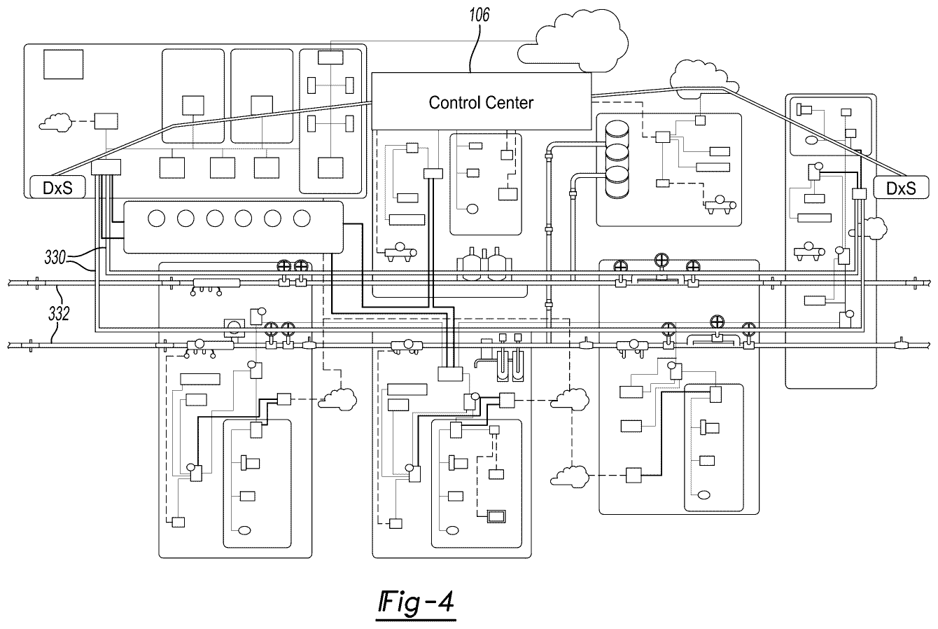

The optical sensing devices 102 configured as fiber-optic sensors (e.g., the SFPES modules 200) can monitor hydrogen, oil, and gas pipelines, including those used for transporting CO₂, particularly in carbon capture and storage (CCS) applications to detect leakage such as illustrated in FIG. 4. Detecting leaks in CO₂ pipelines allows for environmental protection, operational safety, and regulatory compliance. As can be seen in FIG. 4, in one or more embodiments, fiber optics 330 are deployed parallel to one or more pipelines 332, delivering fiber optic connectivity. Utilizing the optical sensing device 102 configured as part of the SFPES modules 200, pipeline leakages can be detected, which eliminates a separate network of leak detection sensors, thereby streamlining maintenance and infrastructure.

In one or more embodiments, the optical sensing devices 102 are configured and arranged as a smart grid capable of performing current measurements, as well as measure temperature and strain. For example, a networking infrastructure can be used to configure electrical grids, making the grids “smart.” The smart grids use optical sensing devices 102 throughout the electrical transmission and distribution network to collect data on usage, demand, and condition of the grid. This information facilitates managing electricity more efficiently and integrating renewable energy sources, thus contributing to sustainability. The optical sensing devices 102 in one or more examples are configured to measure temperature and strain, detecting hotspots and potential failure points in transformers and other equipment as described in more detail herein. Additionally, optical current transformers provide precise current measurements without the saturation issues of traditional transformers.

In one or more embodiments, the optical sensing devices 102 are configured and arranged for operation in energy management. For example, the optical sensing devices 102 can be used to monitor and control energy consumption across different operations as described in more detail herein. By using the optical sensing devices 102 and a network infrastructure to collect and analyze data, energy usage can be optimized, waste reduced, the carbon footprint decreased. The optical sensing devices 102 can be used, for example, to monitor temperature and mechanical strain in power generation equipment, such as turbines and generators, to ensure efficient operation. In renewable energy systems, such as wind turbines (e.g., a train), the optical sensing devices 102 can monitor blade performance and detect potential failures before the failures occur, improving energy efficiency and reducing downtime.

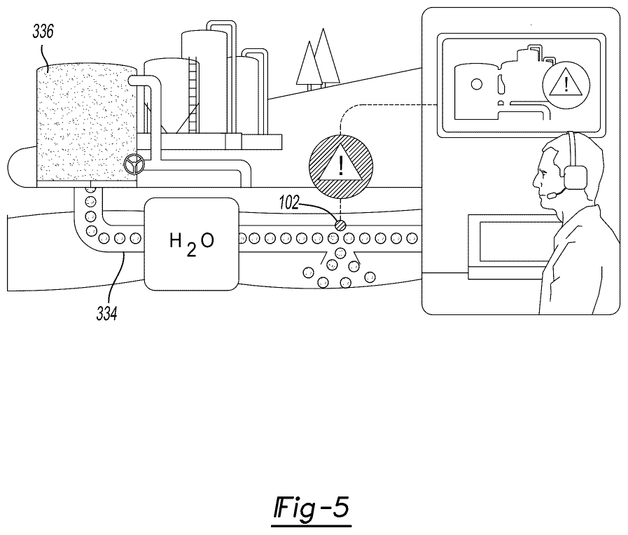

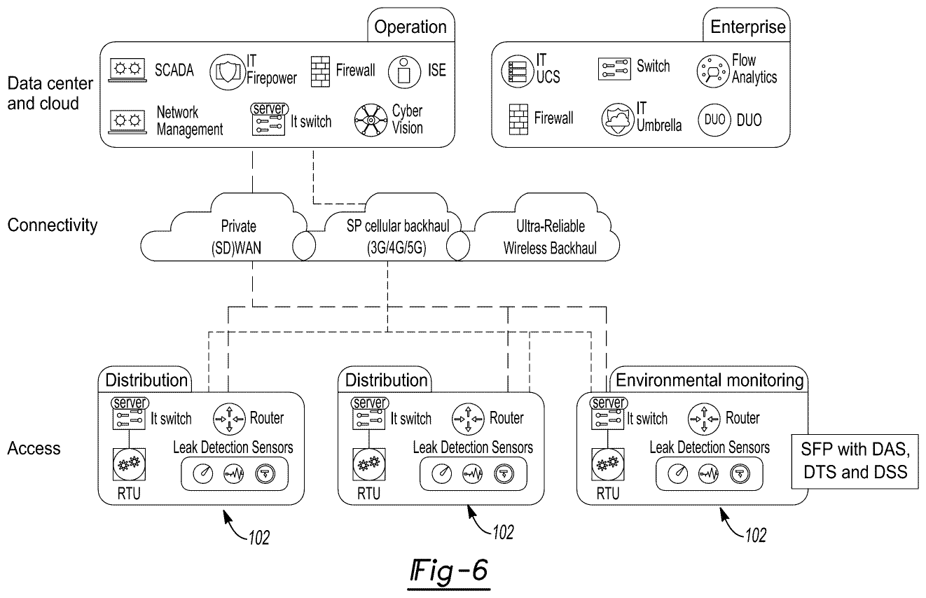

In one or more embodiments, the optical sensing devices 102 are configured and arranged for operation in water management as shown in FIGS. 5 and 6. For example, Internet of Things (IoT) systems can be employed to create smart water management systems that monitor water quality, usage, and distribution. The optical sensing devices 102 are configured in one or more embodiments to detect leaks, measure consumption, and ensure efficient water usage, which facilitates conservation and sustainability. The optical sensing devices 102 can detect leaks in pipelines 334 and tanks 336 by sensing changes in temperature or strain along the infrastructure as described in more detail herein. The optical sensing devices 102 can also monitor the quality of water by detecting contaminants or changes in refractive index, which can indicate the presence of certain pollutants. The optical sensing devices 102 are positioned inline for the leak detection in some embodiments.

In one or more embodiments, the optical sensing devices 102 are configured and arranged for environmental and/or agricultural monitoring. For example, using networking and IoT platforms, the optical sensing devices 102 can be connected and arranged as environmental sensors, including for measuring air quality, temperature, humidity, among other conditions, as described in more detail herein. The data collected can be used, for example, to track environmental health, respond to changes, and implement policies for sustainability. In one or more examples, the optical sensing devices 102 are configured to measure soil temperature and moisture levels, which allow for understanding and predicting environmental changes and agricultural conditions. The optical sensing devices 102 can also monitor seismic activity, providing real-time data for early warning systems in the case of earthquakes or landslides.

In one or more embodiments, the optical sensing devices 102 are configured and arranged for use in monitoring transportation operations. For example, the optical sensing devices 102 are used to implement intelligent transportation systems that reduce emissions. By using the optical sensing devices 102 and network data to optimize traffic flow, public transportation, and fleet management, congestion and pollution can be reduced. In transportation systems, the optical sensing devices 102 in one or more embodiments are be embedded in roads, bridges, and/or railways to monitor traffic loads, structural health, and detect potential hazards. This monitored data is used to optimize traffic flow and maintenance schedules, reducing the environmental impact of transportation networks in one or more examples.

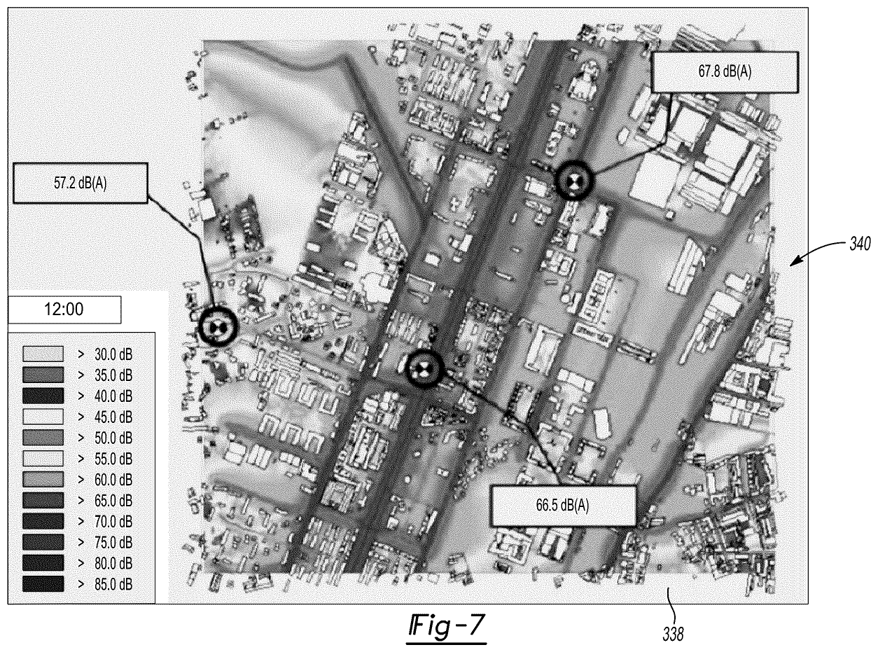

In one or more embodiments, the optical sensing devices 102 are configured and arranged for use in noise pollution and traffic density monitoring as shown in FIG. 7. For example, the optical sensing devices 102 are operable to perform DAS for environmental monitoring, such as traffic noise monitoring and assessment of traffic acoustic emissions on the surrounding areas. Nosie levels can be continuously monitored and reported for display via a user interface 338, allowing for proactive measures to mitigate noise pollution caused by urban activities. That is, the user interface 338 is configured to display an acoustic sound map 340 with decibel levels measured using the DAS functionality of the SFPES modules 200.

For example, traffic noise monitoring can be performed using DAS for environmental monitoring along expressways, such as traffic noise monitoring and assessment of traffic acoustic emissions on the surrounding areas. Additionally, noise levels can be continuously monitored, allowing for proactive measures to mitigate noise pollution caused by the expressway. The DAS enables the collection of real-time traffic data, including vehicle type, speed, and congestion levels in some embodiments. This information can be used to optimize traffic flow, make informed decisions for road infrastructure improvements, and enhance overall safety. Using DAS, expressway structures such as bridges can be continuously monitored for potential damage or abnormal behavior. In one or more embodiments, vibrations, strains, and other structural parameters are captured in real-time, allowing for early detection of issues and prompt maintenance. Additionally, accident-prone areas can be identified to reduce response times for emergency services.

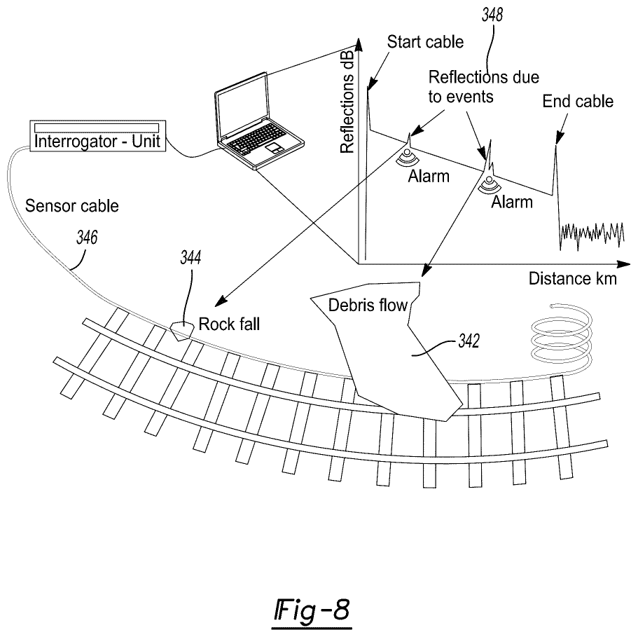

In some examples, the optical sensing devices 102 are configured and arranged for use in railway DAS monitoring as shown in FIGS. 8-12. For example, the SFPES modules 200 are configured to perform debris detection, such as rock fall detection to identify a debris flow 342 or a fallen rock 344 using a sensor cable 346. That is, the sensor cable 346 in some examples is the optical fiber 108 operating to perform DAS functions using data collected by the optical sensing devices 102. For example, one or more acoustic reflections 348 representative of the acoustic events corresponding to the debris flow 342 or the fallen rock 344 are detected as shown in FIG. 8. That is, using threshold analysis in one or embodiments, the acquired DAS data can be used to identify these types of events.

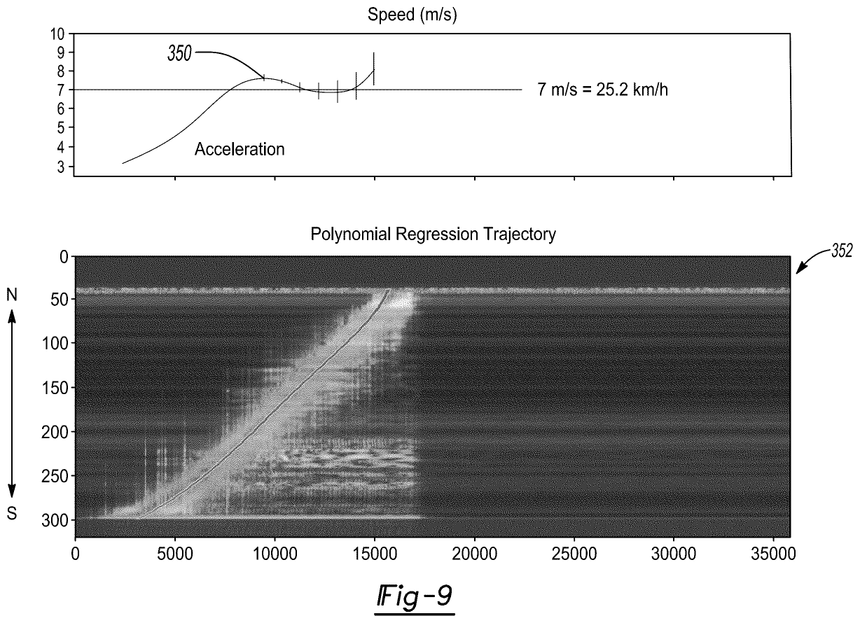

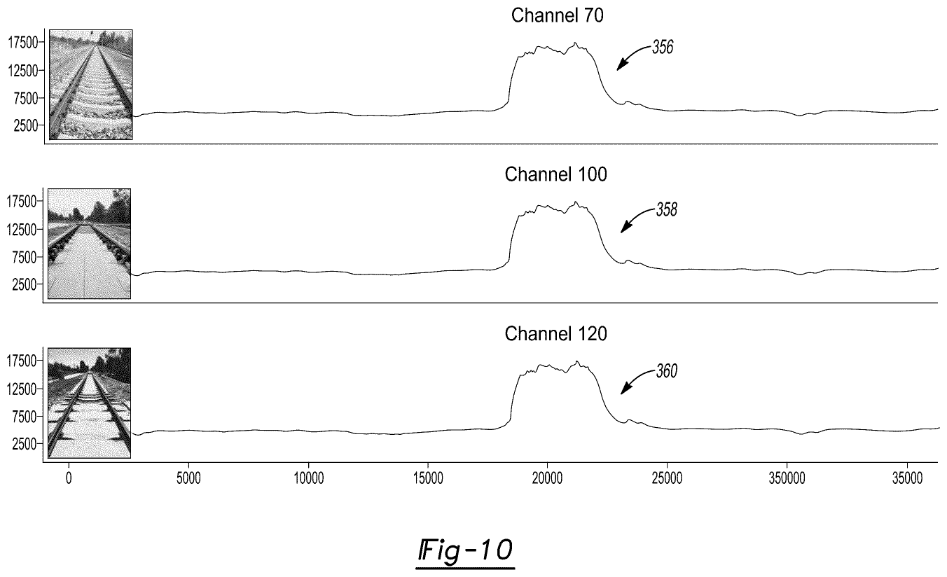

In a similar way, DAS is used to perform real-time and instantaneous speed monitoring as shown in FIG. 9. That is, vibration or acoustic events corresponding to different speed or acceleration events are defined by threshold measurement values. As can be seen, an acceleration curve 350 is generated in various embodiments based on the acquired DAS data 352. In some examples, roadbed condition monitoring is performed as shown in FIG. 10. As can be seen, acoustic events 356, 358, 360 are detected and define acoustic event profiles in some examples that correspond to different roadbed conditions, in this example, the acoustic events 356, 358, 360 correspond to conditions associated with three types of roadbed, namely ballasted, slab, and integral, respectively. It should be appreciated that the DAS data is analyzed in various embodiments to correlate the acoustic events 356, 358, 360 with, for example, predefined corresponding conditions.

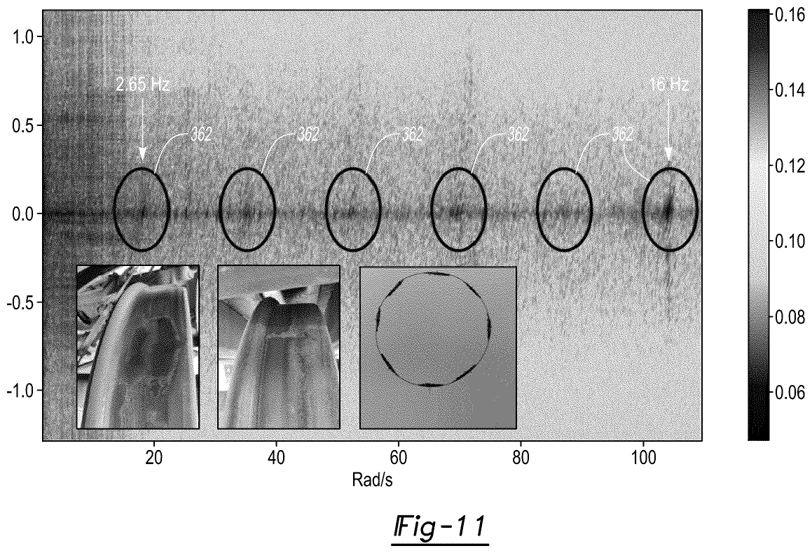

In some examples, flat wheel detection is performed as shown in FIG. 11. That is, the DAS data is used to identify repeating acoustic events 362 (e.g., vibration frequency), which can be compared to normal operation and abnormal operation of a wheel. In the illustrated example, the presence of a wheel scar causes a change in the acoustic signal that is detected by one or more embodiments. It should be noted that the polygonal shapes of some flat scars produce other peaks in the acoustic signal.

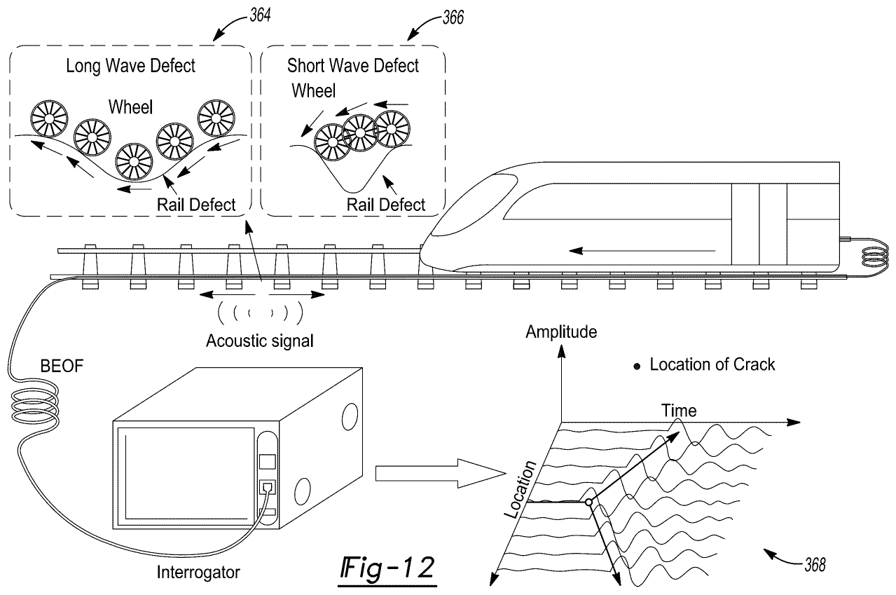

In some examples, rail defect detection is performed as shown in FIG. 12. That is, the DAS data is used to identify a changing duration of the acoustic signal corresponding to a long wave defect 364 and a short wave defect 366. As can be seen, an acoustic amplitude analysis 368 can be performed to detect these different rail defects and the location of the crack in the rail.

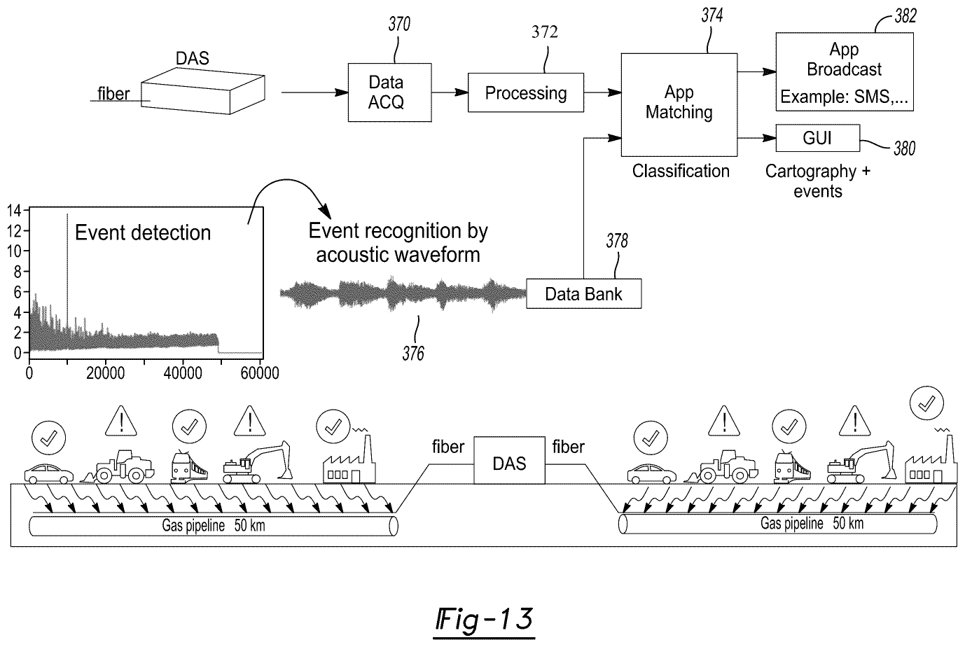

In some examples, DAS is used for vehicle monitoring as shown in FIG. 13. As can be seen, DAS is used to acquire data at 370, such as to perform event detection, wherein the data is process at 372 and a matching operation performed at 374. For example, the matching operation is used to determine a classification of an event detection by comparison of acoustic waveforms 376 to a data bank 378 of stored acoustic events. That is, the data bank 378 includes acoustic waveforms for known or identified events that can be used as part of the matching operation. The detected event can be provided via a GUI 380, as well as broadcast at 382, such as to mobile devices.

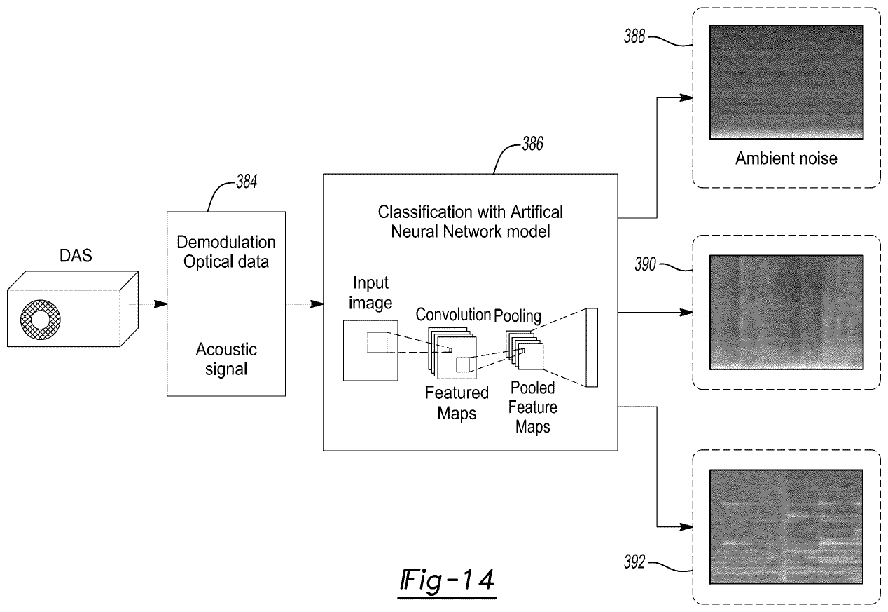

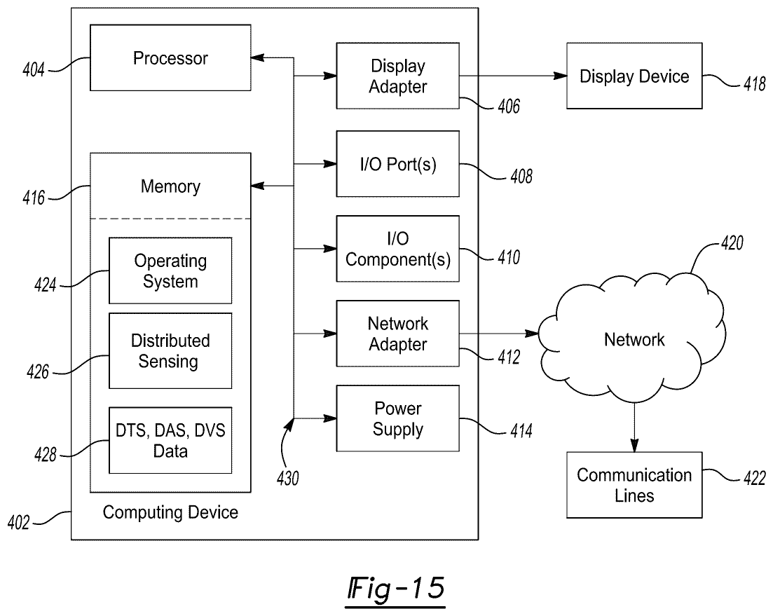

In some examples, event classification is performed in real-time using AI as shown in FIG. 14. As can be seen, the DAS data is acquired and a demodulation operation performed at 384. For example, the optical data is demodulated to an acoustic signal that is then used as an input to a classification operation at 386. For example, classification with an AI network trained using one or more models is performed. As a result, an ambient noise DAS signal 388 can be distinguished from a DAS signal 390 corresponding to a first movement and a DAS signal 392 corresponding to a second movement. The first and second movements can be movements of vehicles, peoples, animals, etc.

In one or more embodiments, the optical sensing devices 102 are configured and arranged for use in building automation. For example, optical sensing devices 102 can be used for smart building automation, where the optical sensing devices 102 are used to optimize lighting, heating, ventilation, and air conditioning (HVAC) systems as described in more detail herein. This can result in energy savings and a reduction in the overall environmental impact of buildings. In smart buildings, the optical sensing devices 102 are configured to manage heating, ventilation, and air conditioning (HVAC) systems by providing precise temperature and occupancy data. This allows for more efficient climate control, leading to energy savings and reduced emissions.

It should be appreciated that the herein described examples and applications for the optical sensing devices 102 are merely for example and the optical sensing devices 102 can be used in other applications and settings. In various embodiments, the optical sensing devices 102 are configured as fiber-SFP devices added to the ICT infrastructure. For example, in operation, the optical sensing devices 102 in one or more embodiments are configured as or integrated with SFP modules or fiber optic modules in a line card to gather information regarding the health and performance of optical networks. It should be appreciated that the SFP modules are hot-swappable interfaces used for both telecommunication and data communications applications. In one or more examples, the optical sensing devices 102 configured as modules plug into a specific port 110 of the switch 104 or on a switch or a network card and link the switch with the fibers of a network.

In various embodiments, optical signal conditioning can be used wherein by monitoring the transmit (Tx) and receive (Rx) power levels, signal changes can be measured that correlate with noise or power fluctuations caused by environmental changes (e.g., a rock falling or a train passing). For example, noise detection and reporting capabilities of various examples can be used to identify noise peaks that can be linked to environmental disturbances.

The various components of one or more embodiments can be implemented by integrating advanced sensing technologies into SFP modules using Micro-Electro-Mechanical Systems (MEMS), photonic integrated circuits (PICs), and nanoscale fabrication. In some examples, sensors are embedded directly within SFP modules to ensure that environmental data (e.g., temperature, acoustic, vibration) is captured and transmitted with minimal delay. In one or more embodiments, an integrated power and data path is provided wherein the SFP modules provide an existing infrastructure for both power and data transmission. By utilizing the SFP form factor, sensors leverage the infrastructure, without the need for separate power supplies and data channels. The modularity of SFP modules also allows for scalable deployment across a network. Each module can be easily replaced or upgraded without the need for extensive system modifications, ensuring minimal disruption and lower maintenance costs.

Other variations and modifications are contemplated. For example, utilizing MEMS technology, pressure sensors, accelerometers, and gyroscopes can be integrated into the SFP module. Photonic Integrated Circuits (PICs) can also be used that enable the integration of multiple optical functions onto a single chip, reducing the footprint. For example, PICs can integrate wavelength division multiplexers (WDM), lasers, and photodetectors within a few square millimeters. Advanced CMOS technology and low-power design is used in some embodiments to ensure that the additional sensors do not exceed the power budget of typical SFP modules (e.g., between 1 W to 2.5 W). Implementing energy-efficient signal processing algorithms on-board the devices in some examples further reduces power consumption, ensuring that the sensors operate within the thermal limits of the SFP module. It should be noted that while various examples are described in connection with SFP modules, one or more embodiments can be adapted to QSFP and QSFP-DD modules for applications with higher data throughput and more complex sensor arrays.

Additionally, by co-integrating optoelectronic components with MEMS sensors on a single platform, a higher degree of miniaturization and functionality is also achieved in various embodiments. This hybrid integration allows for the simultaneous detection of optical power levels, wavelengths, and environmental parameters within the same module. Edge computing capabilities are integrated within the SFP module in one or more embodiments to allow for on-the-fly data processing and anomaly detection. This reduces the data load on central servers and enables immediate local responses to detected environmental changes. Additionally, one or more embodiments implement machine learning algorithms directly within the SFP modules for pattern recognition and predictive maintenance that enhances the ability of the system to anticipate failures and optimize operational efficiency. In some embodiments, one or more of the sub-systems are configured to classify the variations in one or more of temperature, sounds, or vibrations using artificial intelligence as described in more detail herein.

In one or more embodiments, distributed sensing with Fiber Bragg Gratings (FBGs) is used and embedded along the optical fiber within the SFP module to achieve distributed sensing of strain, temperature, and pressure with high spatial resolution. This technique leverages the existing optical path for sensing purposes. Advanced techniques such as Raman and Brillouin scattering can be utilized in some embodiments for precise temperature and strain measurements. These techniques involve analyzing the backscattered light within the fiber, providing detailed insights into environmental conditions.

Quantum Key Distribution (QKD) is used, for example, in applications requiring high security, wherein integrating QKD within the SFP modules can ensure secure transmission of sensor data, protecting the devices from eavesdropping and tampering. And a network topology is used in various embodiments that ensures redundancy and robustness in data paths to further enhance the reliability of the environmental monitoring system.

Thus, one or more embodiments enable the use of fiber optic networks as sensor arrays for real-time monitoring of environmental events by adapting fiber optics and SFP modules (e.g., the SFPES modules 200) to include distributed sensing capabilities. For example, in one or more embodiments, a method for enabling SFPES includes using fiber optics sensing of remote elements with a small form-factor pluggable module (e.g., the SFPES modules 200) that connects a networking device and a fiber optics communication medium. The SFP module is configured to sense and provide data from the fiber optics and communicate the data to a control center associated with the networking device, which may be used in different applications and settings as described in more detail herein. For example, the SFP module is configured to sense data associated with temperatures, acoustics, or vibrations along with the fiber optics as described in more detail herein.

The systems and methods described herein, including the components, processors, servers, controllers etc. can be implemented on or in connection with a computing device 402 as illustrated in FIG. 15. For example, the computing device 402 can be a personal computer, a desktop, a laptop, a tablet, a hand-held computer, a server, a workstation, a mainframe, a wearable computer, a supercomputer, or a combination thereof. However, it is understood that the aforementioned examples of what the computing device 402 may be is non-exhaustive and that the computing device 402 can be any related device. The computing device 402 generally includes a processor 404, a display adapter 406, one or more input/output port(s) 408, one or more input/output component(s) 410, a network adapter 412, a power supply 414, and a memory 416. However, it is understood that the computing device 402 can include any additional components therein and is not required to include any of the listed components (e.g., the processor 404, the display adapter 406, the one or more input/output port(s) 408, the one or more input/output component(s) 410, the network adapter 412, the power supply 414, and the memory 416).

The processor 404 is configured to provide instructions and/or processing power to the computing device 402 so that the computing device 402 can process one or more tasks including the implementation of a software program. It is also understood that the computing device 402 may include any number or processors 404 therein. The display adapter 406 can be a graphics card or a video board that provides the computing device 402 with a capability to display content on a display device 418. For example, the display device 418 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device 418 may be is non-exhaustive and that the display device 418 can be any related device.

The input/output port(s) 408 provides a number of sockets for one or more cables to connect to the computing device 402. It is understood that there may be any number of input/output port(s) 408 on the computing device 402. For example, the input/output port(s) 408 provides a means for the computing device 402 to receive signals and/or data from an external device connected to the computing device 402 via the one or more cables. As another example, the input/output port(s) 408 provides a means for the computing device 402 to send signals and/or data from an external device connected to the computing device 402 via the one or more cables. The input/output component(s) 410 can include one or more components that support the input/output port(s) 408 such as, but not limited to, a switch, a push button, a pressure mat, a float switch, a keypad, a radio receive, or a combination thereof.

A network adapter 412 can be a network interface controller that is configured to provide a means for communicating over a network 420 using one or more communication links 422 and which may be used for distributed sensing as described in more detail herein. The power supply 414 is configured to convert alternating high voltage current (e.g., AC) into direct current (e.g., DC) to provide regulated power to the other components (e.g., the processor 404, the display adapter 406, the one or more input/output port(s) 408, the one or more input/output component(s) 410, the network adapter 412, and the memory 416) of the computing device 402.

Additionally, the memory 416 can be a mass storage device and/or a system memory such as a hard disk drive, a memory card, a solid-state drive, random access memory (RAM), or a combination thereof. The memory 416 is configured to provide a holding place for instructions and data associated with the operation of the computing device 402. The memory 416 can generally include an operating system 424. For example, the operating system 424 is configured to perform distributed sensing 426 and/or process any of the data and/or instructions associated therewith using DTS, DAS, DVS data 428 acquired as described in more detail herein.

Furthermore, a system bus 430 is also included within the computing device 402 that is configured to couple each of the various components (e.g., the processor 404, the display adapter 406, the one or more input/output port(s) 408, the one or more input/output component(s) 410, the network adapter 412, the power supply 414, and the memory 416) of the computing device 402. While the operating environment illustrated within FIG. 15 depicts a particular configuration associated with at least the computing device 402 and the network 420, it is understood that the operating environment may be configured in any way.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs and/or cause one or more processors to perform one or more particular functions. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

Methods and systems are provided for detection using fiber optics. A method includes: providing a trust model that defines a chain of trust among computing devices in an enterprise environment; determining, by a processor, that at least one of the computing devices is at least one of unavailable and unreachable; determining, by the processor, a proxy device from the computing devices based on the trust model; obtaining, by the processor, a temporary digital certificate from the proxy device; and storing, by the processor, the temporary digital certificate to perform future authentications.

What is claimed is:

1. A sensor module, comprising:
a distributed temperature sensing sub-system;
a distributed acoustic sensing sub-system;
a distributed vibration sensing sub-system; and
a small form-factor pluggable (SFP) interface configured to couple to an optical fiber and a switch, wherein the distributed temperature sensing sub-system, the distributed acoustic sensing sub-system, and the distributed vibration sensing sub-system are together configured to monitor optical power levels, wavelengths, temperatures, and voltages using the optical fiber and identify corresponding variations in one or more of temperature, sounds, or vibrations.

2. The sensor module of claim 1, further comprising one or more of a digital optical monitoring sub-system and a digital diagnostics monitoring sub-system configured to perform real-time monitoring of the optical power levels, wavelengths, temperatures, and voltages.

3. The sensor module of claim 1, wherein the SFP interface is configured to couple to an optical communication network having the optical fiber to monitor the optical power levels, wavelengths, temperatures, and voltages.

4. The sensor module of claim 1, wherein the optical fiber is arranged in parallel to a pipeline.

5. The sensor module of claim 1, wherein the distributed temperature sensing sub-system, the distributed acoustic sensing sub-system, and the distributed vibration sensing sub-system are configured to acquire current measurements, temperature measurements, and strain measurements using the optical fiber.

6. The sensor module of claim 1, wherein the distributed temperature sensing sub-system, the distributed acoustic sensing sub-system, and the distributed vibration sensing sub-system are configured are configured to acquire data using the optical fiber, wherein the data corresponds to a detected event associated with a rock fall or a debris flow.

7. The sensor module of claim 1, wherein the distributed temperature sensing sub-system, the distributed acoustic sensing sub-system, and the distributed vibration sensing sub-system are configured to acquire data using the optical fiber, wherein the data corresponds to a detected event associated with a vehicle acceleration.

8. The sensor module of claim 1, wherein the distributed temperature sensing sub-system, the distributed acoustic sensing sub-system, and the distributed vibration sensing sub-system are configured to acquire data using the optical fiber, wherein the data corresponds to a detected event associated with a roadbed condition.

9. The sensor module of claim 1, wherein the distributed temperature sensing sub-system, the distributed acoustic sensing sub-system, and the distributed vibration sensing sub-system are configured to acquire data using the optical fiber, wherein the data corresponds to a detected event associated with a flat wheel detection.

10. The sensor module of claim 1, wherein the distributed temperature sensing sub-system, the distributed acoustic sensing sub-system, and the distributed vibration sensing sub-system are configured to acquire data using the optical fiber, wherein the data corresponds to a detected event associated with a long wave defect of a wheel or a short wave defect of a wheel.

11. The sensor module of claim 1, wherein the distributed temperature sensing sub-system, the distributed acoustic sensing sub-system, and the distributed vibration sensing sub-system are configured to acquire data using the optical fiber, wherein the data is matched to an event recognition based on a stored acoustic waveform.

12. The sensor module of claim 1, wherein the distributed temperature sensing sub-system, the distributed acoustic sensing sub-system, and the distributed vibration sensing sub-system are configured to classify the variations in one or more of temperature, sounds, or vibrations using artificial intelligence.

13. The sensor module of claim 1, wherein the distributed temperature sensing sub-system, the distributed acoustic sensing sub-system, and the distributed vibration sensing sub-system are configured to classify the variations in one or more of temperature, sounds, or vibrations using a matching operation and based on stored acoustic signals.

14. An optical sensor system, comprising:
an optical fiber;
a switch communicatively coupled to a control center; and
a small form-factor pluggable (SFP) sensor having a distributed temperature sensing sub-system, a distributed acoustic sensing sub-system, and a distributed vibration sensing sub-system, wherein the SFP sensor is configured to couple to the optical fiber and the switch, and wherein the distributed temperature sensing sub-system, the distributed acoustic sensing sub-system, and the distributed vibration sensing sub-system are together configured to monitor optical power levels, wavelengths, temperatures, and voltages using the optical fiber and identify corresponding variations in one or more of temperature, sounds, or vibrations.

15. The optical sensor system of claim 14, wherein the SFP sensor is configured as a small form-factor pluggable environmental sensor (SFPES) to detect one or environmental events.

16. The optical sensor system of claim 14, wherein the SFP sensor further comprises one or more of a digital optical monitoring sub-system and a digital diagnostics monitoring sub-system configured to perform real-time monitoring of the optical power levels, wavelengths, temperatures, and voltages.

17. The optical sensor system of claim 14, wherein the optical fiber is arranged in parallel to a pipeline.

18. The optical sensor system of claim 14, wherein the distributed temperature sensing sub-system, the distributed acoustic sensing sub-system, and the distributed vibration sensing sub-system are configured to acquire current measurements, temperature measurements, and strain measurements using the optical fiber.

19. The optical sensor system of claim 14, wherein the distributed temperature sensing sub-system, the distributed acoustic sensing sub-system, and the distributed vibration sensing sub-system are configured to classify the variations in one or more of temperature, sounds, or vibrations using artificial intelligence.

20. A method of distributed sensing, the method comprising:
acquiring temperature data using a distributed temperature sensing sub-system of a small form-factor pluggable (SFP) sensor coupled to an optical fiber;
acquiring acoustic data using a distributed acoustic sensing sub-system of the small form-factor pluggable (SFP) sensor coupled to the optical fiber;
acquiring vibration data using a distributed vibration sensing sub-system of the small form-factor pluggable (SFP) sensor coupled to the optical fiber;
monitoring optical power levels, wavelengths, temperatures, and voltages using the acquired temperature data, acoustic data, and vibration data; and
identifying corresponding variations in one or more of temperature, sounds, or vibrations.
